(19) United States
(12) Patent Application Publication
(10) Pub. No.: US 2010/0067510 A1
(43) Pub. Date: Mar. 18, 2010

(54) Vehicle Multi-Media Communications Point Source

(76) Inventors: Thomas Ross Roper, Hoover, AL (US); Kendall Aaron Bauldree, Gardendale, AL (US)

Correspondence Address: Maynard Cooper & Gale, PC, 1901 Sixth Avenue North, 2400 Regions/Harbert Plaza, BIRMINGHAM, AL, 35203-2618, US

(21) Appl. No.: 12/561,852

(22) Filed: Sep. 17, 2009

Related U.S. Application Data
(60) Provisional application No. 61/097,737, filed on Sep. 17, 2008.

(51) Int. Cl. H04H 20/67

(52) U.S. Cl. 370/339; 370/328

(57) ABSTRACT

An apparatus to provide a multi-media communications access point for vehicles that permits subscribing devices to transmit file data, and telephonic or video data to other remote devices via an HSDPA RF communications network. The apparatus includes a wireless access switch, a cellular data transceiver, an optional data network signal booster, two antennas, and an input-output interface panel. Firmware in the wireless access point allows high-speed access to the cellular data network and point to point mobile communications from one apparatus to another minor apparatus.

This application claims the benefit of filing priority under 35 U.S.C. §119 and 37 C.F.R. §1.78 from U.S. Provisional Application Ser. No. 61/097,737 filed Sep. 17, 2008, for Vehicle Multi-Media Communications Point Source. All information disclosed in those prior applications is incorporated herein by reference.

### FIELD OF THE INVENTION

The present invention relates generally to the transmission of data over a global communications network, such as the Internet. In greater particularity, the present invention relates to the receipt and transmission of telecommunications data from a communications point source in a vehicle. In greater particularity, the present invention also relates to devices providing access to a global communications network, such as the Internet, to the passengers in a car vehicle in a consolidated electronics package.

### BACKGROUND OF THE INVENTION

While single point wireless access to the Internet have been prevalent in homes and businesses since the mid to late 1990s, the availability of Internet access to transportation vehicles, such as automobiles has been limited. Further, even when available to vehicles, such systems are complicated to configure and even more complicated to access. These systems also typically were part of an integrated vehicle automobile network like the “On-Star” warning system and have complicated overhead and must be installed during vehicle manufacturing.

Certainly, notebook computers have had available to them high-speed cellular data modems from which a notebook computer can be provided internet access from any cellular network accessible location, and whether moving or not, since the late 1990s, but such access points are specific to each computer having been preconfigured to be used on the recipient laptop computer and they do not provide Internet access to other devices held by other vehicle passengers that would benefit from such access. Moreover, such access systems are relatively slow and costly since they require expensive online accounts.

Hence, what is needed in the vehicle industry, and especially in automobiles, is a relatively low cost, easily installed device that would provide liberal and simple access to the Internet for all types of communications needs, whether data, telephonic (i.e. voice over Internet Protocol or “VoIP”), or video.

### SUMMARY OF THE INVENTION

In summary, the present apparatus is a compact, self-contained Internet access point that may installed into a vehicle of choice, such as an automobile, to transmit data, telephone, or video data. The apparatus includes a wireless router switch, a cellular data transceiver an input-output interface panel, two antennas and, optionally, a data network signal booster.

### BRIEF DESCRIPTION OF THE DRAWINGS

FIG. 1 is a block diagram showing a generalized view of the communications path from the invention to various remote communications destinations;

FIG. 2 is a system block diagram of the invention;

FIG. 3 is a system block diagram of another embodiment of the invention;

FIG. 4 is an exterior view of the wireless access portion of the apparatus showing the I/O interface connection exterior;

FIG. 5 is a functional processing diagram showing the major functions and subsystems of the network router/switch and cellular data transceiver; and,

FIG. 6 is a data flow diagram showing point to point (apparatus to apparatus) communications path through the supporting cellular network and associated infrastructure.

### DESCRIPTION OF THE PREFERRED EMBODIMENTS

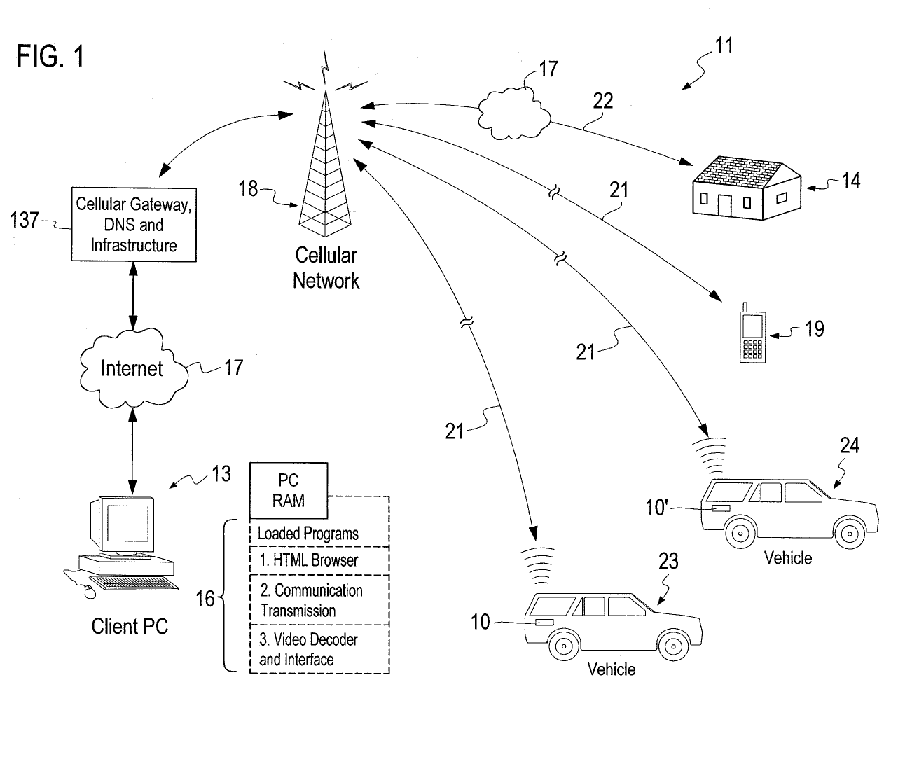

Referring to the drawings for a better understanding of the function and structure of the invention, FIG. 1 shows the communications environment 11 in which apparatus 10 operates. Apparatus 10 is installed into a vehicle 23 in a convenient location and, generally, after manufacturing of the vehicle, and likely at a dealer options installation location. The apparatus 10 is not dependant upon preconfigured electronics of the vehicle and, as such, can be incorporated into any vehicle that provides a compatible power supply. Additional apparatus units 10′ may be installed in additional vehicles 24 to permit point to point data communications. The apparatus 10 maintains constant communication through an available cellular network 18 which provides a backbone network superstructure to access and promote data through the Internet 17. The network 18 allows point to point communications from vehicle to vehicle and vehicle to cellular phone 19 over wireless communications paths 21, and from a vehicle to land-line subscribers within a home 14 via communications path 22, which may include the Internet 17. A requesting personal computer (“PC”) 13 having the appropriate software running thereon 16, may also make data requests to the apparatus 10 via the Internet 17, cellular network 18, and wireless cellular pathway 137 to the apparatus 10 to access audio and video data in real-time from devices connected to the apparatus 10. Communications over the Internet through a VoIP handset may also be accomplished for devices within the signal access foot-print of the apparatus 10, as will be described.

By providing a single point Internet access infrastructure within a vehicle, any person utilizing a communications device 10 within the footprint can access and freely communicate to another communications device within the footprint of another similar apparatus 10′, whether within the cellular network confines (e.g. 21) or outside via the Internet 17 (e.g. 22). Moreover, the data communications speed is far greater than current cellular voice modem performance benchmarks (e.g. far greater than T-mobile's voice EDGE network).

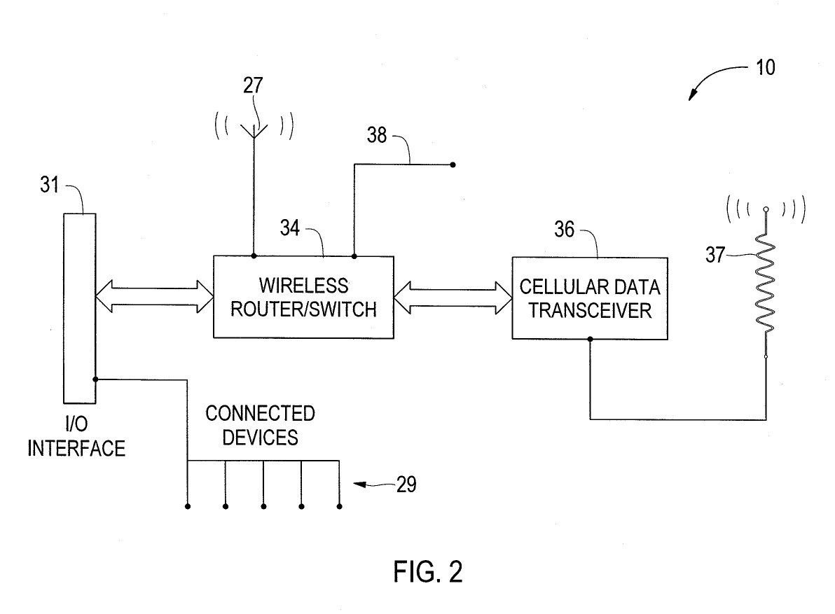

Referring now to FIG. 2, the apparatus 10 includes various components to achieve the real-time exchange of communications data to a remotely located communications device. A network router switch 34 assigns an IP address to any device to which it will provide communications services. Several wireless access router switches are commercially available that may be utilized for switch 34. For example, DOVADO FZ-LLC, offers a USB Mobile Broadband Router (aka “UMR”) that supports USB based 3G network modems. In particular, the Dovado router provides a wireless access point (i.e. an 802.11 B/G/N WLAN Access Point) with internal NAT router and DHCP server capabilities. It supports any USB modems that exhibit 3G/HSPA, CDMA2000xEVDO, and iBURST™ features, including speeds of 21 Mbps HSDPA/5.76 Mbps HSPA+.

While the Dovado UMR access point is the preferred access point for the herein disclosed apparatus, other wireless access points such as Linksys Corporation's mobile wireless-G Router part no. WRT54G3GV2-ST can provide sufficient performance to accommodate the herein described system 10. In general, any mobile broadband access point having the above described capabilities with the Dovado access point should suffice. Preferably, wireless switch 34 provides wireless 802.11B/G/ and, optionally, N router capabilities to any device requesting access and meeting such standards.

An antennae 27 and power supply voltage input 38, along with a general I/O interface panel 31, allow the apparatus 10 to communicate with other devices. If used in a vehicle, the power supply is connected to a 12 volt power supply line from the automobile's power chassis, and the antennae 27 may be positioned adjacent to the housing 12 of the apparatus 10. A suitable power supply source may be furnished from a 12V cigarette light receptacle connected to the access point 34 via a 12V power cord. The access point 34 includes the ability to receive an RJ-45 data input via I/O interface ports 31 and can be configured to achieve the communications performance required for herein described apparatus 10. A second antennae 37 such as a magnetic, wind shield, or permanent antennae configured to transmit cellular data signals is positioned advantageously upon or within the vehicle to promote good signal strength and to facilitate communications with a cell tower or cell repeater, as is known in the art.

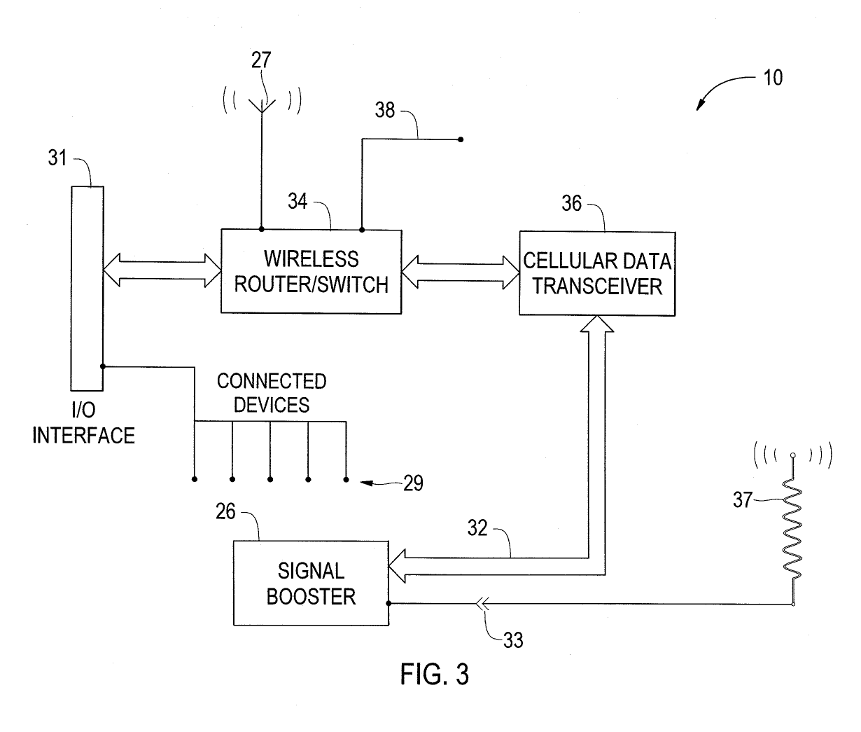

Cellular data transceiver 36 provides data communications between wireless switch 34 and cellular data towers and associated cellular data infrastructure. The transceiver is preferably connected to switch 34 via a USB interface. Optionally, a data signal booster 26 (see FIG. 3) amplifies the cellular transmission signals issued by transceiver 36 over link 32 and allows for greater communications transfer rates with the cellular infrastructure where signal strength fluctuations affect data transfer speeds.

An example of a suitable transceiver for the herein disclosed apparatus 10 is a Compass 885 USB modem available from Sierra Wireless, Inc. based in British Columbia, Canada. While the Sierra USB modem is preferred, other USB based wireless modems Data sheets and technical specifications for these cellular transceivers, also known as “wireless wide-area modems for HSPA networks,” maybe found at www.sierrawireless.com the contents of which are hereby incorporated by reference in their entireties. As may be understood, various types of USB based modems are available from various manufactures, and Huawei, Novatel, and Vodafone all offer suitable USB based Modems. However, it is preferable that these modems meet the following specifications so that video and voice communications exhibit satisfactory performance to a user within a vehicle: (1) HSDPA/HSUPA/UMTS: 3GPP R5 GSM/GPRS/EDGE: 3GPP R99; (2) operating frequencies of UMTS/HSDPA/HSUPA 850/1900/2100 MHz GSM/GPRS/EDGE 850/900/1800/1900 MHz; and (3) SIM/USIM card standards (6 PIN SIM card interface). Any suitable USB based modem will necessarily include firmware having cellular communication protocols to transmit data packets to and from a wireless cellular network such that data loss is minimized and speed is maximized. Performance of such USB modems typically provide broadband (i.e. greater than 52 KB bi-directional transmission rate) speeds for the apparatus 10 in order to properly stream video and audio data to a remote device. Notably, as indicated in the specifications above, such communications occur over the HSDPA cellular data network, and not over the standard voice cellular network. Data communication speeds over a cellular voice network are not suitable for the herein described system. Typical broadband speeds utilizing HSDPA average download speeds of 7.2 Mbps and an average upload speeds of 2.0 Mbps (i.e. HSDPA Cat. Aug. 6, 1912). These speeds are superior ranges in order to stream live audio, live video, or Internet graphics data to or from the apparatus 10, and providing a high-speed data command download path in order to control the apparatus 10, if desired. It should be noted that while a component topology is disclosed, the inventors envision that a monolithic solution featuring a wireless access point with an integrated HSDPA modem will be available in the future.

As shown in FIG. 3, a data signal radio frequency booster 26 (i.e. an RF amplifier) may be incorporated to amplify the cellular transmission signals issued by transceiver 36 over link 32 and may allow for greater communications transfer rates within the cellular infrastructure, depending upon the range of a unit from a cellular tower. A satisfactory RF amplifier for the purposes of the herein disclosed apparatus is an AirBooster® 350 made by Sierra Wireless, Inc. The AirBooster 350 is an RF amplifier suitable for receiving the output from data modem 36 via link 32 and boosting it.

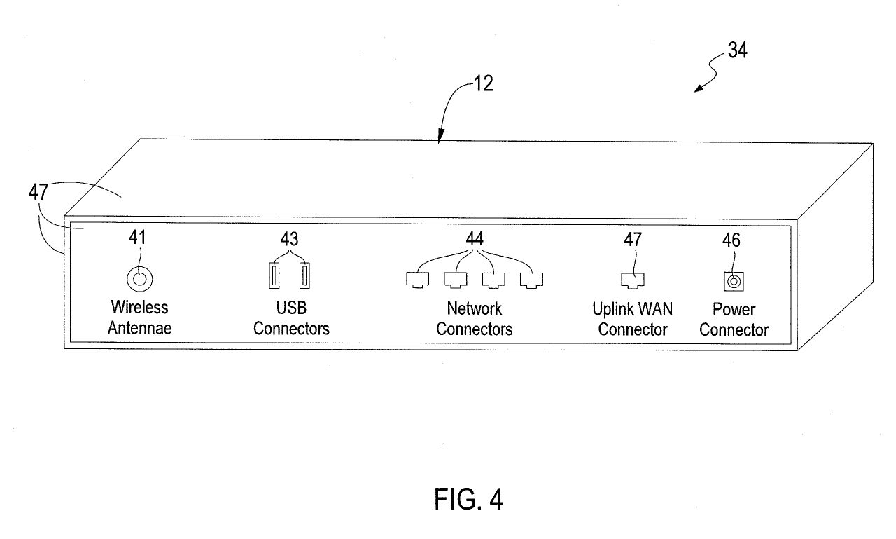

Turning now to FIG. 4, the physical connections that are available between the apparatus and various devices that subscribe to its services may be seen. Housing 12 is typically made of light weight metal 47, and provides a wireless switch antenna interface 41, an uplink connector 47 for connecting broadband apparatuses, standard RJ-45 network connectors 44, and a power connector 46 that is connected to an automobile power chassis to supply power to the unit.

The USB 43 and network connectors 44 allow for a rich diversity of devices to connect to the apparatus 10, in the event that a wireless connection via the access point 34 is blocked by interference or other technical reasons. For example, a wired VoIP handset such as offered by Skype Technologies S.A (“Skype”) may be connected to apparatus 10 to make uninterrupted calls via the Skype network. Similarly, a video input may be provided to the apparatus 10 so that a remote PC or remote mobile user may access video feed from a video source, such as a camera, including audio surveillance feeds, connected to access point 34.

Similarly, the inventors fully envision that a vehicle in which the apparatus 10 is located may take advantage of local broadband Internet access to communicate and update vehicle systems functions, such as navigation aids and engine monitoring diagnostics. Such systems may prefer the reliability and security of a wired link to the Internet via apparatus 10 in lieu of a wireless connection via access point 34.

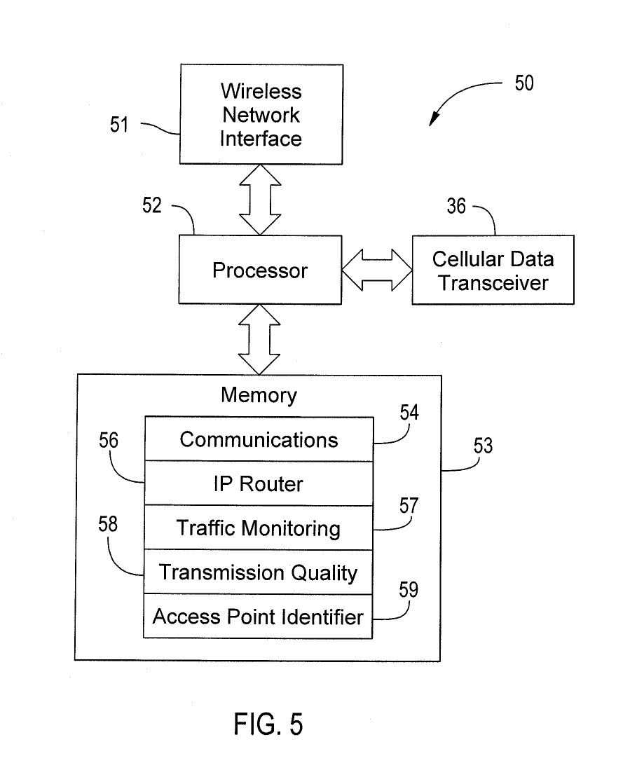

Referring to FIG. 5, it may be seen that the network router 34 includes a network interface 51, a wireless transceiver 36, a processor 52, and various firmware and high-speed memory 53 from which processor 52 executes instructions. Memory 53 includes communications protocol 54, an IP router algorithmic processing subroutine 56, a traffic monitor subroutine 57, a software module for transmission quality control 58, and an access point identifier 59 (e.g., assignment and monitoring of MAC addresses). Processor 52 utilizes the subroutine's present in its memory 53 in order to receive data via network interface 51 and transmit that data in a secure and reliable format via wireless cellular data modem 36. Processor 52 also controls command access to and from switch 34 to receive and promote instructions to processor 56 within switch 34 in order to execute instructions within it. Processor 52, in conjunction with cellular modem 36, controls all of the communications from the apparatus 10 to and from cellular data modem 36, and further to tower 18 and cellular network 137.

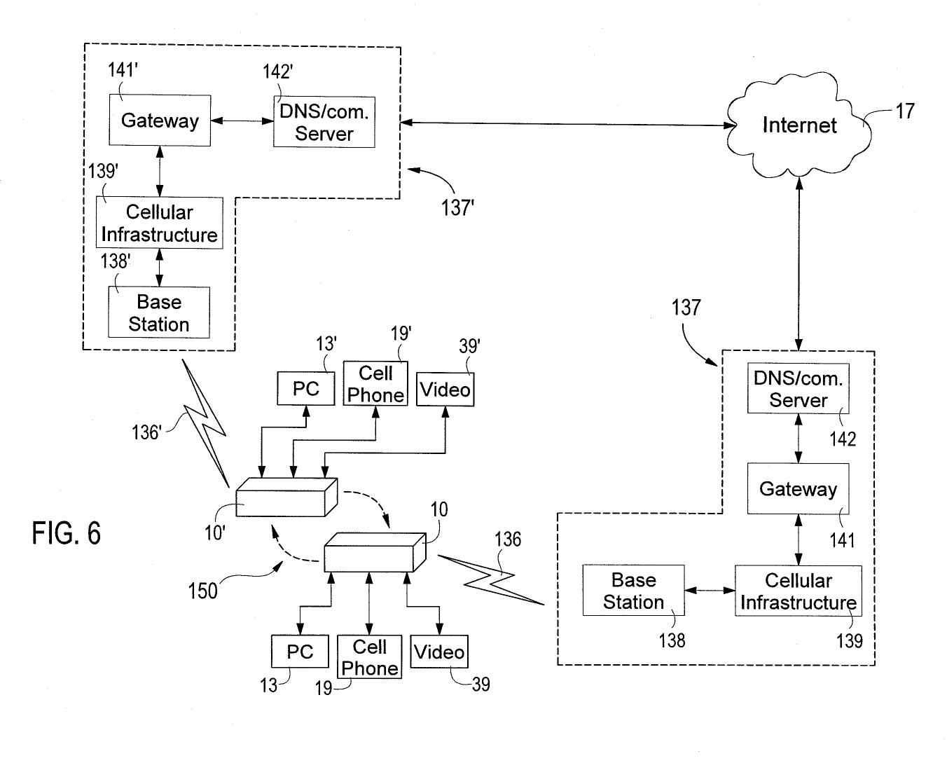

Referring now to FIG. 6, it may be seen that vehicle to vehicle communications may occur through apparatus 10. Two vehicles 23 and 24 (see FIG. 1) having an apparatus 10, 10′ may engage in vehicle to vehicle digital communication 150 as if they were on the same local network. Specifically, apparatuses 10, 10′ communicate via the HSDPA 136 to a cellular network 137, such as AT&T, Sprint, T-Mobile, etc. to obtain an assigned IP address. Such an address may be a static or dynamic address, depending upon which cellular network is accessed and, typically, depending upon subscriber contract terms. A bases station 138 provides access to the network 137 and network infrastructure 139, so that gateway electronics 141 can provide access to apparatus 10 for DNS services 142 on the Internet 17.

Access point 34 is assigned an IP address from the cellular infrastructure 139 to the extent that ports within the router subsystem 56 are available or “open” as permitted by the cellular provider and their cellular network 137. For VoIP transmissions, whether audio or combined audio and video, it is preferable for port 5005 to be open on the USB modem 36 so that IP addressing can be known and utilized to communicate to the apparatus 10 from a remote PC without the reliance of a third party server holding the IP address and associated MAC address of the access point 34 and any tethered devices 29 on the local access point network. However, in topologies of third party service providers retaining MAC identities, finder IDs are assigned to each device on the apparatus 10 network so that a user accessing the third party server may locate a particular broadcasting unit. The cellular provider provides a gateway 141 from within its cellular infrastructure 139 to additional routers and DNS servers 142, and on to the Internet 17. A Remote PC 13, VoIP phone 19, or other device is then able to access the apparatuses 10, 10′ by its known pre-assigned IP address assigned by cellular infrastructure 139. Further, since router 34 has also been assigned an IP address to, for example, another VoIP handset 19″ and holds a table within its memory assigning the MAC address for the handset 19′, remote handset 19 is able to communicate directly with handset 19′ and vice versa. It is important to note that while the cellular infrastructure 139 assigns an IP address to the access point 34, the IP address of the handset 19, or any other device tethered to the access point, that IP address may be determined from any remotely communicating device running suitable software to access and communicate with the device if the device has registered its MAC address with the third party server. The result is that, even given the inherent mobility of a vehicle, location is irrelevant as long as an Internet connection is available to the vehicle via apparatus 10.

As is known in the industry, third party portal providers offer sophisticated communication services in which servers access, locate, and direct communications from devices assigned local address status on apparatus 10 to and from other accessible apparatuses 10′ as discussed above. Such servers repeatedly receive “pings” from remote devices that allow for the continual discernment of a MAC address of a device assigned a local IP address from apparatus 10. For example, a SKYPE server may track a VoIP phone 19 connected to the Internet 17 via apparatus 10, identify and save its gateway and local IP address from the apparatus network on a distributed server topology such that other SKYPE subscribers may monitor and make calls to the user with phone 19 via apparatus 10. In this manner, for example, two VoIP phone users may make calls to one another (e.g. 19 to 19′) while in a vehicle having apparatuses 10 and 10′ installed therein and roaming from cell to cell within a cellular networks. Similar services exist for video calls 39 (also via SKYPE or similar services), or PC 13 to PC 13′ communications. Since the HSDPA networks provide broadband speeds, VoIP and Video telecommunications from vehicle to vehicle will appear smooth and continuous between devices tethered to apparatuses 10 and 10′.

While the inventors have shown access to the apparatus 10 via a remote personal computer 13, the inventors envision and fully anticipate that other types of data viewing devices such as PDAs, mobile phones, laptop computers, and similar devices, will be able to access the apparatus 10 in the same manner as described above and retrieve video data, such as movies, in real-time to each of them. For example Slingmedia offers a SlingPlayer mobile that currently runs on the Pocket PC 1.5 operating system, Windows Smart phones, Palm OS Systems, and the Mobile Symbian OS. Achos has similar devices running the Android OS. The applications that run on these mobile devices and PDAs allow for remote viewing of video data on apparatus 10 in the same manner that video data would be available for viewing on a PC 13 from the Internet.

Further, while the above apparatus 10 has been shown to utilize various available elements that include the capabilities necessary for implementation of the apparatus 10, the inventors fully expect that a reduction of the above referenced elements into a single printed circuit wire board, or even a monolithic silicon design, is anticipated. Nevertheless, the above referenced discrete elements may be installed and arranged within the confines of a vehicle, such as an automobile, in locations such as a trunk or under a dashboard so that the apparatus 10 may be unobtrusive and yet electronically readily accessible.

While I have shown my invention in one form, it will be obvious to those skilled in the art that it is not so limited but is susceptible of various changes and modifications without departing from the spirit thereof.

Having set forth the nature of the present invention, what is claimed is:

1. A vehicle communications point source to the Internet, comprising:
a. an HSDPA wireless data modem;
b. a wireless access point having a NAT router and a DHCP server, wherein said access point is in digital communication with said data modem through a USB interface;
c. a cellular antenna electrically connected to said data modem and positioned advantageously with respect to said vehicle to transceive signals with a cellular communications tower;
d. an antennae positioned within said vehicle and electrically connected to said access point for propagating and receiving signals from devices wishing to access said point source; and,
e. a vehicle 12 volt power supply connected to said access point for supplying power to said access point.

2. The system as recited in claim 1, further including a signal booster in electrical communication with said data modem for boosting the signal of said same.

3. The system as recited in claim 2, wherein said cellular antennae is position on the exterior of said automobile and said access point antennae is co-located with said access point and within said trunk.

4. The system as recited in claim 1, wherein said wireless access point further includes at least one RJ45 connector for digital communication with a device tethered to said access point.

5. The system as recited in claim 4, further including a VoIP handset tethered to said wireless access point for VoIP communications through said cellular communications tower.

6. The system as recited in claim 5, wherein said data modem and said access point are positioned within the trunk of an automobile and said 12 volt power supply is connected to the power chassis of said automobile.

7. The system as recited in claim 6, wherein said cellular antennae is position on the exterior of said automobile and said access point antennae is co-located with said access point and within said trunk.

8. The system as recited in claim 7, wherein said system communicates with said cellular communications tower at broadband speeds.

9. The system as recited in claim 8, including a video communications device tethered to said access point for providing video transceiving services to a remote party.

10. The system as recited in claim 9, including a data communications device tethered to said access point for transferring files to a remote PC.

11. The system as recited in claim 1, further including a VoIP handset tethered to said wireless access point for VoIP communications through said cellular communications tower.

12. The system as recited in claim 11, wherein said data modem and said access point are positioned within the trunk of an automobile and said 12 volt power supply is connected to the power chassis of said automobile.

13. The system as recited in claim 12, wherein said cellular antennae is position on the exterior of said automobile and said access point antennae is co-located with said access point and within said trunk.

14. A vehicle communications point source system for providing broadband access to the Internet for said vehicle, comprising:
a. means for providing modem communications over an HSDPA communications network to a cellular communications tower;
b. means for providing a wireless access point having a NAT router and a DHCP server, wherein said access point means is in digital communication with said modem means through a USB interface;
c. a cellular antenna electrically connected to said modem means and positioned advantageously with respect to said vehicle to transceive signals with said cellular communications tower;
d. an antennae positioned within said vehicle and electrically connected to said access point means for propagating and receiving signals from devices wishing to access said point source system; and,
e. means for providing a 12 volt power supply to said access point means from a vehicle power chassis.

15. The system as recited in claim 14, wherein said system communicates with said cellular communications tower at broadband speeds.

16. The system as recited in claim 15, including a video communications device tethered to said access point means for providing video transceiving services to a remote party.

17. The system as recited in claim 16, wherein said modem means and said access point means are positioned within the trunk of said vehicle and said 12 volt power supply means is connected to the power chassis of said vehicle.

18. The system as recited in claim 17, wherein said cellular antennae is position on the exterior of said vehicle and said access point means antennae is co-located with said access point means and within said trunk.

19. A vehicle communications system for providing broadband communications from one moving vehicle to another remotely located vehicle over the Internet, comprising:
a. a first vehicle communications point source system for providing broadband access to the Internet for said first vehicle, comprising:
i. an HSDPA wireless data modem;
ii. a wireless access point having a NAT router and a DHCP server, wherein said access point is in digital communication with said data modem through a USB interface;
iii. a cellular antenna electrically connected to said data modem and positioned advantageously with respect to said first vehicle to transceive signals with a cellular communications tower;
iv. an antennae positioned within said first vehicle and electrically connected to said access point for propagating and receiving signals from devices wishing to access said point source; and,
v. a vehicle 12 volt power supply connected to said access point for supplying power to said access point;
b. a second vehicle communications point source system for providing broadband access to the Internet for said second vehicle, comprising:
i. an HSDPA wireless data modem;
ii. a wireless access point having a NAT router and a DHCP server, wherein said access point is in digital communication with said data modem through a USB interface;
iii. a cellular antenna electrically connected to said data modem and positioned advantageously with respect to said second vehicle to transceive signals with a cellular communications tower;
iv. an antennae positioned within said second vehicle and electrically connected to said access point for propagating and receiving signals from devices wishing to access said point source; and,
v. a vehicle 12 volt power supply connected to said access point for supplying power to said access point; and,
c. wherein said first and second vehicle communications point source systems each include data communications devices tethered to each respective access points; and,
d. wherein each said tethered device transceives digital communications to between one another.

20. The system as recited in claim 19 wherein each said data communications device is a VoIP handset.

21. The system as recited in claim 20, wherein each said vehicle is an automobile and each includes a trunk, and wherein each said data modem and each said access point are positioned within the trunk of each respective automobile and each said 12 volt power supply is connected to the power chassis of each respective automobile.

22. The system as recited in claim 21, wherein each said cellular antennae is position on the exterior of said each respective automobile and each said access point antennae is co-located with its respective access point.

23. The system as recited in claim 22, wherein each said system includes a video communications device tethered to each said access point for providing video transceiving services between two parties each located in separate said automobiles.

24. The system as recited in claim 23, further including a signal booster in each point source system in electrical communication with each respective data modem for boosting the signals of said same.
